(19) United States
(12) Patent Application Publication
(10) Pub. No.: US 2022/0177616 A1
(43) Pub. Date: Jun. 9, 2022

(54) PROCESS AND REACTOR ASSEMBLY FOR THE ENHANCEMENT OF HYDRODYNAMICS IN A GAS-SOLIDS FLUIDIZED BED REACTOR

(71) Applicant: Borealis AG, Vienna (AT)

(72) Inventors: Gunter Weickert, Ahaus (DE); Vasileios Kanellopoulos, Linz (AT); Eric-Jan Prinsen, Aadrop (NL); Pablo Ivan Aguayo Arellano, Linz (AT); Markku Vahteri, Porvoo (FI); Juha Salminen, Porvoo (FI); Jari-Jussi Ruskeeniemi, Porvoo (FI); Ravindra Tupe, Espoo (FI); Erno Elovainio, Porvoo (FI); Klaus Nyfors, Porvoo (FI)

(21) Appl. No.: 17/599,027

(22) PCT Filed: Apr. 6, 2020
(86) PCT No.: PCT/EP2020/059811

§ 371 Date: Sep. 28, 2021

(30) Foreign Application Priority Data
Jun. 4, 2019 (EP) 19178243.2

(51) Int. Cl. C08F 10/06; B01J 8/38; B01J 8/44; B01J 19/24; B01J 8/18

(52) U.S. Cl. CPC C08F 10/06; B01J 8/388; B01J 8/44; B01J 19/2465; B01J 2219/1943; B01J 2208/00061; B01J 2208/0007; B01J 2208/00088; B01J 2208/00265; B01J 8/1845

(57) ABSTRACT

A process for polymerizing olefin monomer(s) in a gas-solids olefin polymerization reactor comprising a top zone; a middle zone, which comprises a top end in direct contact with said top zone and which is located below said top zone, the middle zone having a generally cylindrical shape; and a bottom zone, which is in direct contact with a bottom end of the middle zone and which is located below the middle zone; comprising the following steps: introducing a fluidization gas stream into the bottom zone; polymerizing olefin monomer(s) in the presence of a polymerization catalyst in a dense phase formed by particles of a polymer of the olefin monomer(s) suspended in an upwards flowing stream of the fluidization gas in the middle zone; introducing a jet gas stream through one or more jet gas feeding ports in a jet gas feeding area of the middle zone at the dense phase in the middle zone of the gas-solids olefin polymerization reactor; wherein the kinetic energy (E_{JG}) input in the reactor by the jet stream is between 1.5 and 50 times higher than the kinetic energy (E_{FG}) input in the reactor by the fluidization gas stream (FG).

The present invention is directed to the polymerization of olefins in a gas-solids olefin polymerization reactor.

### BACKGROUND

Gas-solids olefin polymerization reactors are commonly used for the polymerization of alpha-olefins such as ethylene and propylene as they allow high flexibility in polymer design and use of various catalyst systems. A common gas-solids olefin polymerization reactor variant is the fluidized bed reactor.

Typically, in gas-solids olefin polymerization reactors the fluidization gas moving upwards through the dense phase, in which the polymerization reaction takes place and the polyolefin particles are polymerized, forms gas bubbles, preferably being created above an optional distribution plate. These bubbles quickly move up towards the top of the reactor, preferably in the center of the bed, thus pushing the powder upwards into the entrainment zone, near to the gas exit. In such reactors a certain mixing regime is developed, based on which the solids follow the so called ‘two loop’ mixing pattern as depicted in FIG. 1 (G. Hendrickson, ‘Electrostatics and gas phase fluidized bed polymerization reactor wall sheeting’, Chemical Engineering Science 61, 2006, 1041-1064).

These bubbles entrain polyolefin solids, mostly powder, into the disengaging zone near to the fluidization gas exit. Such entrained solids might deposit in parts of the production plant placed downstream of the reactor leading to fouling and possible blockage of these components. Hence, the described hydrodynamic pattern as found in conventional gas-solids fluidization bed reactors limits the filling degree of the reactor, as the bed level can only be up to a certain height without significantly increasing entrainment of solids. Furthermore, the average fluidized bulk density is limited as bubbles are distributed all over the fluidized bed generally lowering the efficiency and productivity of such reactors. Therefore, generally, the reactor productivity is limited by the hydrodynamic pattern as observed in conventional gas-solids fluidized bed reactors.

Furthermore, the relatively low polyolefin powder concentration in the upper reactor zone can lead to stronger adhesion of the reactive powder to the inner reactor wall resulting in generation of wall sheeting and lump formation (cf. FIG. 1).

Moreover, there is a general need in fluidized bed reactor technology related to improvement of mixing efficiency. Improved mixing efficiency improves mass and heat transfer resulting in increased operability, performance and handling of demanding material (i.e. sticky polymer grades or material with poor flowability).

The solution as known from the prior art for reducing the solids carry over and increasing the reactor throughput in gas-solids fluidization reactors without losing cooling capacity is based on a fluidization effect according to which part of the fluidizing gas, solid, or liquid and/or mixture of them is introduced in the fluidized bed reactor at a point above the distribution plate but below the top end of the reactor cylindrical body (dense phase of the reactor). This stream allows the destruction of axially moving powder fountains and generates strong centrifugal forces to separate gas from solids.

Hence, e.g. U.S. Pat. No. 5,428,118 discloses a process for polymerizing olefins in a gas-solids olefin polymerization reactor in which hot fluidization gas withdrawn from the reactor is reintroduced into the disengaging zone via a tangential flow of gas or gas-solids in order to reduce polyolefin powder entrainment into the fluidization gas circulation system.

WO 2017/025330 A1 discloses a process for polymerizing olefins in a gas-solids olefin polymerization reactor in which a cooled stream of partially condensed fluidization gas withdrawn from the reactor is reintroduced into the disengaging zone in order to reduce polyolefin powder entrainment into the fluidization gas circulation system.

However, there is a general need for improvement of efficient destruction of the mentioned hydrodynamic pattern in gas-solids fluidized bed reactors. Furthermore, another general need to further enhance the solid-gas separation efficiency of such reactors is to avoid solid entrainment at improved reactor loadings, further improving the reactor productivity. Finally, it is another object to improve reactor productivity generally by increasing the fluidized bulk density.

### SUMMARY OF THE INVENTION

It has been surprisingly discovered that by providing kinetic energy to the fluidization gas stream and the jet gas stream in a certain ratio that the kinetic energy provided to the jet gas stream is higher than the kinetic energy provided to the fluidization gas stream, the carry-over of particles of the polyolefin into the stream of disengaging fluidization gas withdrawn from the top zone of the gas-solids olefin polymerization reactor is reduced and at the same time the cooling capacity of the process is not sacrificed. In other words, a higher bulk density of the dense phase can be obtained over the whole polymerization process.

Therefore, the present invention relates to a process for polymerizing olefin monomer(s) in a gas-solids olefin polymerization reactor comprising:
a top zone (1);
a middle zone (2), which comprises a top end in direct contact with said top zone and which is located below said top zone (1), the middle zone (2) having a generally cylindrical shape; and
a bottom zone (3), which is in direct contact with a bottom end of the middle zone (2) and which is located below the middle zone (2); comprising the following steps:
a) introducing a fluidization gas stream (FG) into the bottom zone (3);
b) polymerizing olefin monomer(s) in the presence of a polymerization catalyst in a dense phase formed by particles of a polymer of the olefin monomer(s) suspended in an upwards flowing stream of the fluidization gas in the middle zone (2);
c) introducing a jet gas stream (JG) through one or more jet gas feeding ports (5) in a jet gas feeding area of the middle zone (2) at the dense phase in the middle zone (2) of the gas-solids olefin polymerization reactor;
   wherein
   the kinetic energy (E_{JG}) input in the reactor by the jet stream (JG) is between 1.0 and 50 times higher than the kinetic energy (E_{FG}) input in the reactor by the fluidization gas stream (FG) as expressed by relation (I)

$$1.0 \leq \frac{{E}_{JG}}{{E}_{FG}} \leq 50 \qquad ( I )$$

wherein the kinetic energy of the fluidization gas (E_{FG}) is calculated according to equation (II):

$${E}_{FG} = {P}_{FG} \cdot {V}_{FG} \cdot ln ( \frac{{P}_{FG}}{{P}_{FG} - h \cdot ρ \cdot g} ) \qquad ( II )$$

with
E_{FG} being the energy dissipated by the expansion of the fluidisation gas into the fluidized bed, [W]
P_{FG} being the pressure of the fluidisation gas at the bottom of the gas-solids olefin polymerization reactor, [Pa]
V_{FG} being the volumetric flow rate of the fluidisation gas, [m³/s]
h being the bed height of the collapsed bed, [m]
ρ being the bulk density of the collapsed bed, [kg/m³]
g being the gravity constant, [m/s²]
   and wherein the kinetic energy of the jet gas (E_{JG}) is calculated according to equation (III):

$${E}_{JG} = {P}_{JG} \cdot {V}_{JG} \cdot ln ( \frac{{V}_{{FG}_{2}}}{{V}_{JG}} ) \qquad ( III )$$

with
E_{JG} being the energy dissipated by the expansion of the jet gas into the fluidized bed, [W]
P_{JG} being the pressure of the jet gas at entry in the gas-solids olefin polymerization reactor, [Pa]
V_{FG2} being the volumetric flow rate of the fluidisation gas, [m³/s]
V_{JG} being the volumetric flow rate of the jet gas, [m³/s]

The present invention is also related to a reactor assembly for polymerizing olefin monomer(s) comprising
a gas-solids olefin polymerization reactor comprising:
a top zone (1);
a middle zone (2), which comprises a top end in direct contact with said top zone (2) and which is located below said top zone (1), the middle zone (2) having a generally cylindrical shape; and
a bottom zone (3), which is in direct contact with a bottom end of the middle zone (2) and which is located below said middle zone (2);
one or more feeding ports (5) located in a jet gas feeding area of the middle zone (2);
a first line (6) for feeding a fluidization gas stream (FG) into the bottom zone (3) of the gas-solids olefin polymerization reactor,
a second line (7) for withdrawing a stream comprising fluidization gas from the top zone (1) of the gas-solids olefin polymerization reactor,
a third line (8) for introducing a jet gas stream (JG) into the middle zone (2) of the gas-solids olefin polymerization reactor via the one or more feeding ports (5), and
means (9) located in the first line (6) for providing kinetic energy to the fluidization gas stream (FG) prior to entry of the reactor and means (10) located in the third line (8) for providing kinetic energy to the jet gas stream (FG) prior to entry of the reactor,
   wherein
   the means for providing kinetic energy to the fluidization gas stream (9) and the means for providing kinetic energy to the jet gas stream (10) are configured so that the kinetic energy (E_{JG}) input in the reactor by the jet stream (JG) is between 1.0 and 50 times higher than the kinetic energy (E_{FG}) input in the reactor by the fluidization gas stream (FG) as expressed by relation (I)

$$1.0 \leq \frac{{E}_{JG}}{{E}_{FG}} \leq 50 \qquad ( I )$$

wherein the kinetic energy of the fluidization gas (E_{FG}) is calculated according to equation (II):

$${E}_{FG} = {P}_{FG} \cdot {V}_{FG} \cdot ln ( \frac{{P}_{FG}}{{P}_{FG} - h \cdot ρ \cdot g} ) \qquad ( II )$$

with
E_{FG} being the energy dissipated by the expansion of the fluidisation gas into the fluidized bed, [W]
P_{FG} being the pressure of the fluidisation gas at the bottom of the gas-solids olefin polymerization reactor, [Pa]
V_{FG} being the volumetric flow rate of the fluidisation gas, [m³/s]
h being the bed height of the collapsed bed, [m]
ρ being the bulk density of the collapsed bed, [kg/m³]
g being the gravity constant, [m/s²]
   and wherein the kinetic energy of the jet gas (E_{JG}) is calculated according to equation (III):

$${E}_{JG} = {P}_{JG} \cdot {V}_{JG} \cdot ln ( \frac{{V}_{{FG}_{2}}}{{V}_{JG}} ) \qquad ( III )$$

with
E_{JG} being the energy dissipated by the expansion of the jet gas into the fluidized bed, [W]
P_{JG} being the pressure of the jet gas at entry in the gas-solids olefin polymerization reactor, [Pa]
V_{FG2} being the volumetric flow rate of the fluidisation gas, [m³/s]
V_{JG} being the volumetric flow rate of the jet gas, [m³/s]

Further, the present invention is related to the use of the process and/or the reactor assembly according to the present invention as described above and below for reducing the carry-over of particles of the polyolefin of the olefin monomer(s) into the second stream withdrawn from the top zone of the gas-solids olefin polymerization reactor.

Still further, the present invention is related to the use of the process and/or the reactor assembly according to the present invention as described above and below for increasing the bulk density of the dense phase during polymerization.

### DETAILED DESCRIPTION

### Definitions

As it is well understood in the art the superficial gas velocity denotes the velocity of the gas in an empty construction. Thus, the superficial gas velocity within the middle zone is the volumetric flow rate of the gas (in m³/s) divided by the cross-sectional area of the middle zone (in m²) and the area occupied by the particles is thus neglected.

By fluidization gas is meant the gas comprising monomer, and eventual comonomers, chain transfer agent and inert components which form the upwards flowing gas in the gas-solids olefin polymerization reactor and in which the polymer particles are suspended, e.g. in the fluidized bed of a fluidized bed reactor. The unreacted gas is collected at the top of the reactor, optionally compressed, optionally cooled and optionally returned to the reactor. As it is understood by the person skilled in the art the composition of the fluidization gas is not constant during the cycle. Reactive components are consumed in the reactor and they are added into the circulation line for compensating losses.

A gas-solids olefin polymerization reactor is a polymerization reactor for heterophasic polymerization of gaseous olefin monomer(s) into polyolefin powder particles, which comprises three zones: in the bottom zone the fluidization gas is introduced into the reactor; in the middle zone, which usually has a generally cylindrical shape, the olefin monomer(s) present in the fluidization gas are polymerized to form the polymer particles; in the top zone the fluidization gas is withdrawn from the reactor. In certain types of gas-solids olefin polymerization reactors a fluidization grid (also named distribution plate) separates the bottom zone from the middle zone. In certain types of gas-solids olefin polymerization reactors the top zone forms a disengaging or entrainment zone in which due to its expanding diameter compared to the middle zone the fluidization gas expands and the gas disengages from the polyolefin powder.

The dense phase denotes the area within the middle zone of the gas-solids olefin polymerization reactor with an increased fluidized bulk density due to the formation of the polymer particles. In certain types of gas-solids olefin polymerization reactors, namely fluidized bed reactors, the dense phase is formed by the fluidized bed.

“Entrained polyolefin powder” or “carry-over of particles” denotes polyolefin particles which are withdrawn together with the fluidization gas in the second stream of fluidization gas from the top zone of the gas-solids olefin polymerization reactor.

“Circulation gas line” denotes the system of lines or tubes through which the second stream of fluidization gas is reintroduced into the gas-solids olefin polymerization reactor as first stream of fluidization gas and as jet gas stream.

“Bulk density” (or “fluidized bed density” for fluidized bed polymerization reactors) denotes mass of polymer powder divided by the volume of the reactor, excluding the optional disengaging zone.

In the present invention the different streams are measured as volume streams so that also the split of these streams is meant as volume split measured in v/v.

Differences in pressure ΔP are measured in bar if not noted otherwise.

The present text refers to diameter and equivalent diameter. In case of non-spherical objects the equivalent diameter denotes the diameter of a sphere or a circle which has the same volume or area (in case of a circle) as the non-spherical object. It should be understood that even though the present text sometimes refers to diameter, the object in question needs not be spherical unless otherwise specifically mentioned. In case of non-spherical objects (particles or cross-sections) the equivalent diameter is then meant.

### Polymerization

The olefin monomer(s) polymerized in the process of the present invention are typically alpha-olefins having from 2 to 12 carbon atoms, preferably from 2 to 10 carbon atoms. Preferably, the olefin monomer(s) are ethylene or propylene, optionally together with one or more other alpha-olefin monomer(s) having from 2 to 8 carbon atoms. Especially preferably the process of the present invention is used for polymerizing ethylene, optionally with one or more comonomers selected from alpha-olefin monomer(s) having from 4 to 8 carbon atoms; or propylene, optionally together with one or more comonomers selected from ethylene and alpha-olefin monomer(s) having from 4 to 8 carbon atoms.

Thus, the polymer material is preferably selected from alpha-olefin homo- or copolymers having alpha-olefin monomer units of from 2 to 12 carbon atoms, preferably from 2 to 10 carbon atoms. Preferred are ethylene or propylene homo- or copolymers. The comonomer units of ethylene copolymers are preferably selected from one or more comonomers selected from alpha-olefin monomer(s) having from 4 to 8 carbon atoms. The comonomer units of propylene copolymers are preferably selected from one or more comonomers selected from ethylene and alpha-olefin monomer(s) having from 4 to 8 carbon atoms.

In one preferred embodiment of the invention, in the method according to the invention a polypropylene homo- or copolymer is polymerized from the olefin monomer(s) and optional comonomer(s). Preferably, in this embodiment, the polymerization is carried out at a temperature of 50-100° C. under a pressure of 15-25 barg. Preferably, the molar ratios of the reactants are adjusted as follows: a C₂/C₃ ratio of 0-0.05 mol/mol for random polypropylenes, and a molar C₂/C₃ ratio of 0.2-0.7 mol/mol for block polypropylenes. Generally, the H₂/C₃ molar ratio in this embodiment is adjusted to 0-0.05 mol/mol. Moreover, in this embodiment, the propylene feed is preferably adjusted to 20-40 t/h, whereby the comonomer feed is 0-15 t/h and hydrogen feed is 1-10 kg/h.

In a second preferred embodiment of the invention, in the method according to the invention a polyethylene homo- or copolymer is polymerized from the olefin monomer(s) and optional comonomer(s). Preferably, in this embodiment, the polymerization is carried out at a temperature of 50-100° C. under a pressure of 15-25 barg. Preferably, the molar ratios of the reactants are adjusted as follows: a C₄/C₂ ratio of 0.1-0.8 mol/mol for polyethylene-1-butene copolymers and a C₆/C₂ ratio of 0-0.1 mol/mol for polyethylene-1-hexene copolymers. Generally, the H₂/C₂ molar ratio in this embodiment is adjusted to 0-0.05 mol/mol. Moreover, in this embodiment, the ethylene feed is preferably adjusted to 15-20 t/h, whereby the comonomer feed is adjusted to 0-20 t/h for 1-butene and to 0-7 t/h for 1-hexene. Preferably, hydrogen feed is 1-100 kg/h and diluent feed (propane): 30-50 t/h.

### Polymerization Catalyst

The polymerization in the gas-solids olefin polymerization reactor is conducted in the presence of an olefin polymerization catalyst. The catalyst may be any catalyst which is capable of producing the desired olefin polymer. Suitable catalysts are, among others, Ziegler-Natta catalysts based on a transition metal, such as titanium, zirconium and/or vanadium catalysts. Especially Ziegler-Natta catalysts are useful as they can produce olefin polymers within a wide range of molecular weight with a high productivity.

Suitable Ziegler-Natta catalysts preferably contain a magnesium compound, an aluminium compound and a titanium compound supported on a particulate support.

The particulate support can be an inorganic oxide support, such as silica, alumina, titania, silica-alumina and silica-titania. Preferably, the support is silica.

The average particle size of the silica support can be typically from 6 to 100 μm. However, it has turned out that special advantages can be obtained if the support has median particle size from 6 to 90 μm, preferably from 10 to 70 μm.

The magnesium compound is a reaction product of a magnesium dialkyl and an alcohol. The alcohol is a linear or branched aliphatic monoalcohol. Preferably, the alcohol has from 6 to 16 carbon atoms. Branched alcohols are especially preferred, and 2-ethyl-1-hexanol is one example of the preferred alcohols. The magnesium dialkyl may be any compound of magnesium bonding to two alkyl groups, which may be the same or different. Butyl-octyl magnesium is one example of the preferred magnesium dialkyls.

The aluminium compound is chlorine containing aluminium alkyl. Especially preferred compounds are aluminium alkyl dichlorides and aluminium alkyl sesquichlorides.

The titanium compound is a halogen containing titanium compound, preferably chlorine containing titanium compound. Especially preferred titanium compound is titanium tetrachloride.

The catalyst can be prepared by sequentially contacting the carrier with the above mentioned compounds, as described in EP-A-688794 or WO-A-99/51646. Alternatively, it can be prepared by first preparing a solution from the components and then contacting the solution with a carrier, as described in WO-A-01/55230.

Another group of suitable Ziegler-Natta catalysts contains a titanium compound together with a magnesium halide compound acting as a support. Thus, the catalyst contains a titanium compound on a magnesium dihalide, like magnesium dichloride. Such catalysts are disclosed, for instance, in WO-A-2005/118655 and EP-A-810235.

Still a further type of Ziegler-Natta catalysts are catalysts prepared by a method, wherein an emulsion is formed, wherein the active components form a dispersed, i.e. a discontinuous phase in the emulsion of at least two liquid phases. The dispersed phase, in the form of droplets, is solidified from the emulsion, wherein catalyst in the form of solid particles is formed. The principles of preparation of these types of catalysts are given in WO-A-2003/106510 of Borealis.

The Ziegler-Natta catalyst is used together with an activator. Suitable activators are metal alkyl compounds and especially aluminium alkyl compounds. These compounds include alkyl aluminium halides, such as ethylaluminium dichloride, diethylaluminium chloride, ethylaluminium sesquichloride, dimethylaluminium chloride and the like. They also include trialkylaluminium compounds, such as trimethylaluminium, triethylaluminium, tri-isobutylaluminium, trihexylaluminium and tri-n-octylaluminium. Furthermore they include alkylaluminium oxy-compounds, such as methylaluminiumoxane (MAO), hexaisobutylaluminiumoxane (HIBAO) and tetraisobutylaluminiumoxane (TIBAO). Also other aluminium alkyl compounds, such as isoprenylaluminium, may be used. Especially preferred activators are trialkylaluminiums, of which triethylaluminium, trimethylaluminium and tri-isobutylaluminium are particularly used. If needed the activator may also include an external electron donor. Suitable electron donor compounds are disclosed in WO-A-95/32994, U.S. Pat. Nos. 4,107,414, 4,186,107, 4,226,963, 4,347,160, 4,382,019, 4,435,550, 4,465,782, 4,472,524, 4,473,660, 4,522,930, 4,530,912, 4,532,313, 4,560,671 and 4,657,882. Also electron donors consisting of organosilane compounds, containing Si—OCOR, Si—OR, and/or Si—NR₂ bonds, having silicon as the central atom, and R is an alkyl, alkenyl, aryl, arylalkyl or cycloalkyl with 1-20 carbon atoms are known in the art. Such compounds are described in U.S. Pat. Nos. 4,472,524, 4,522,930, 4,560,671, 4,581,342, 4,657,882, EP-A-45976, EP-A-45977 and EP-A-1538167.

The amount in which the activator is used depends on the specific catalyst and activator. Typically triethylaluminium is used in such amount that the molar ratio of aluminium to the transition metal, like Al/Ti, is from 1 to 1000, preferably from 3 to 100 and in particular from about 5 to about 30 mol/mol. Also metallocene catalysts may be used. Metallocene catalysts comprise a transition metal compound which contains a cyclopentadienyl, indenyl or fluorenyl ligand. Preferably the catalyst contains two cyclopentadienyl, indenyl or fluorenyl ligands, which may be bridged by a group preferably containing silicon and/or carbon atom(s). Further, the ligands may have substituents, such as alkyl groups, aryl groups, arylalkyl groups, alkylaryl groups, silyl groups, siloxy groups, alkoxy groups or other heteroatom groups or the like. Suitable metallocene catalysts are known in the art and are disclosed, among others, in WO-A-95/12622, WO-A-96/32423, WO-A-97/28170, WO-A-98/32776, WO-A-99/61489, WO-A-03/010208, WO-A-03/051934, WO-A-03/051514, WO-A-2004/085499, EP-A-1752462 and EP-A-1739103.

### Prior Polymerization Stages

The polymerization in the gas-solids olefin polymerization reactor may be preceded by prior polymerization stages, such as prepolymerization or another polymerization stage conducted in slurry or gas phase. Such polymerization stages, if present, can be conducted according to the procedures well known in the art. Suitable processes including polymerization and other process stages which could precede the polymerization process of the present invention are disclosed in WO-A-92/12182, WO-A-96/18662, EP-A-1415999, WO-A-98/58976, EP-A-887380, WO-A-98/58977, EP-A-1860125, GB-A-1580635, U.S. Pat. Nos. 4,582,816, 3,405,109, 3,324,093, EP-A-479186 and U.S. Pat. No. 5,391,654. As it is well understood by the person skilled in the art, the catalyst needs to remain active after the prior polymerization stages.

### Gas-Solids Olefin Polymerization

In the gas-solids olefin polymerization reactor polymerization is conducted using gaseous olefin monomer(s) in which the polymer particles are growing.

The present process is suitable for any kind of gas-solids olefin polymerization reactors suitable for the polymerization of alpha-olefin homo- or copolymers. Suitable reactors are e.g. continuous-stirred tank reactors or fluidized bed reactors. Both types of gas-solids olefin polymerization reactors are well known in the art.

Preferably the gas-solids olefin polymerization reactor is a fluidized bed reactor.

In a fluidized bed reactor the polymerization takes place in a fluidized bed formed by the growing polymer particles in an upwards moving gas stream. In the fluidized bed the polymer particles, containing the active catalyst, come into contact with the reaction gases, such as monomer, comonomer(s) and hydrogen which cause polymer to be produced onto the particles.

Thereby, in one preferred embodiment the fluidized bed reactor can comprise a fluidization grid which is situated below the fluidized bed thereby separating the bottom zone and the middle zone of the reactor. The upper limit of the fluidized bed is usually defined by a disengaging zone in which due to its expanding diameter compared to the middle zone the fluidization gas expands and the gas disengages from the polyolefin powder. Fluidized bed reactors with disengaging zone and fluidization grid are well known in the art. Such a fluidized bed reactor suitable for the process of the present invention is shown in FIG. 2.

In another preferred embodiment the fluidized bed reactor does not comprise a fluidization grid. The polymerization takes place in a reactor including a bottom zone, a middle zone and a top zone. The bottom zone, which has a generally conical shape, forms the lower part of the reactor in which the base of the fluidized bed is formed. The base of the bed forms in the bottom zone with no fluidization grid, or gas distribution plate, being present. Above the bottom zone and in direct contact with it is the middle zone, which has a generally cylindrical shape. The middle zone and the upper part of the bottom zone contain the fluidized bed. Because there is no fluidization grid there is a free exchange of gas and particles between the different regions within the bottom zone and between the bottom zone and the middle zone. Finally, above the middle zone and in direct contact therewith is the top zone which has a generally conical shape tapering upwards.

The bottom zone of the reactor has a generally conical shape tapering downwards. Because of the shape of the zone, the gas velocity gradually decreases along the height within said bottom zone. The gas velocity in the lowest part is greater than the transport velocity and the particles eventually contained in the gas are transported upwards with the gas. At a certain height within the bottom zone the gas velocity becomes smaller than the transport velocity and a fluidized bed starts to form. When the gas velocity becomes still smaller the bed becomes denser and the polymer particles distribute the gas over the whole cross-section of the bed. Such a fluidized bed reactor without fluidization grid is described in EP-A-2 495 037 and EP-A-2 495 038.

In a gas-solids olefin polymerization reactor the upwards moving gas stream is established by withdrawing a fluidization gas stream as second gas stream from the top zone of the reactor, typically at the highest location. The second gas stream withdrawn from the reactor is then usually cooled and re-introduced to the bottom zone of the reactor as first stream of fluidization gas. In a preferred embodiment, the fluidization gas of the second gas stream is also compressed in a compressor. More preferably, the compressor is located upstream of the cooler. Preferably, the gas is filtered before being passed to the compressor. Additional olefin monomer(s), eventual comonomer(s), hydrogen and inert gas are suitably introduced into the circulation gas line. It is preferred to analyze the composition of the circulation gas, for instance, by using on-line gas chromatography and adjust the addition of the gas components so that their contents are maintained at desired levels.

The polymerization is generally conducted at a temperature and pressure where the fluidization gas essentially remains in vapour or gas phase. For olefin polymerization the temperature is suitably within the range of 30 to 110° C., preferably 50 to 100° C. The pressure is suitably in the range of 1 to 50 bar, preferably 5 to 35 bar.

In order to remove entrained polyolefin powder, the circulation gas line, i.e. the line for withdrawing the second stream, preferably comprises at least one cyclone. The cyclone has the objective of removing the entrained polymer material from the circulation gas. The polymer stream recovered from the cyclone can be directed to another polymerization stage, or it may be returned into the gas-solids olefin polymerization reactor or it may be withdrawn as the polymer product.

In the case the polymer stream recovered from the cyclone is returned into the gas-solids polymerization reactor the polymer stream is returned through one or more feedings ports, which are different feeding ports as the one or more feeding ports for introducing the jet gas stream into the dense phase in the middle zone of the gas-solids olefin polymerization reactor.

Preferably, the jet gas stream in the third line comprises not more than 5 wt % solid polymer with respect to the total weight of the jet gas stream, more preferably not more than 3 wt % solid polymer, even more preferably not more than 2 wt % solid polymer and most preferably not more than 1 wt % solid polymer.

### Ratio of the Kinetic Energy of the Jet Gas Stream and the Fluidization Gas Stream

According to the process and the reactor assembly of the present invention the fluidization gas fed in the bottom zone of the reactor is provided with kinetic energy beforehand. Accordingly, also the jet gas stream fed into the dense zone of the reactor via jet gas feeding ports is provided with kinetic energy prior to entry in the reactor.

Thereby, the kinetic energy (E_{JG}) input in the reactor by the jet stream is between 1.0 and 50 times higher than the kinetic energy (E_{FG}) input in the reactor by the fluidization gas stream according to relation (111)

$$1.0 \leq \frac{{E}_{JG}}{{E}_{FG}} \leq 50 \qquad ( I )$$

Preferably, the kinetic energy (E_{JG}) input in the reactor by the jet stream is between 1.5 and 25 times higher than the kinetic energy (E_{FG}) input in the reactor by the fluidization gas stream according to relation (IV)

$$1.5 \leq \frac{{E}_{JG}}{{E}_{FG}} \leq 25 \qquad ( IV )$$

Even more preferably, the kinetic energy (E_{JG}) input in the reactor by the jet stream is between 2.0 and 15 times higher than the kinetic energy (E_{FG}) input in the reactor by the fluidization gas stream according to relation (V)

$$2.0 \leq \frac{{E}_{JG}}{{E}_{FG}} \leq 15 \qquad ( V )$$

The means for providing kinetic energy can be any means for providing the gas streams with kinetic energy. Such means comprise blowers, compressors, such as screw compressors, and fans. Preferably, the means are blowers or compressors. More preferably, the means are blowers. In one preferred embodiment, the means for providing kinetic energy to the fluidization gas is at least one blower and the means for providing kinetic energy to the jet gas is at least one screw compressor.

In an particularly preferred embodiment of the invention, the means for providing kinetic energy to the jet gas stream in the third line is a flash pipe of a preceding reactor, preferably a polymerization reactor, more preferably a polypropylene polymerization reactor and most preferably a loop polymerization reactor for polypropylene. In such a case, the jet gas stream can include not only fluidization gas, but a solids-gas mixture as withdrawn from the flash pipe. Hence, preferably, the reactor assembly according to the present invention further comprises:
one or more flash pipe feeding ports located in a jet gas feeding area of the middle zone; and
a sixth line for introducing a flash pipe gas stream into the bottom zone of the gas-solids olefin polymerization reactor via the one or more flash pipe feeding ports.

The fluidization gas is withdrawn from the top zone of the reactor in a second line. Preferably, the second line is split into a third line and the first line. The first line is introduced into the bottom zone of the reactor, whereas the third line is introduced into the reactor through one or more feeding ports at a jet gas feeding area of the middle zone into the dense phase in the middle zone of the reactor. Thereby, the stream in the third line is not mixed with particles of the polymer of the olefin monomer(s) before entering the reactor and thus is not introduced into the reactor through feeding ports for reintroducing particles of the polymer of the olefin monomer(s) into the gas-solids olefin polymerization reactor.

Preferably, the jet gas feeding area of the middle zone is located on the surface of the middle zone between the top end and 50% of the total height of the middle zone, whereas the bottom end corresponds to 0% and the top end corresponds to 100% of the total height of the middle zone. More preferably, the jet gas feeding area of the middle zone is located on the surface of the middle zone between the top end and 70% of the total height of the middle zone.

Preferably, the jet gas stream is introduced through the one or more feeding ports into the dense phase in the middle zone of the gas-solids olefin polymerization reactor in an introduction angle α of 5° to 75°, preferably 10° to 65°, most preferably 15° to 60°. The introduction angle is the angle between a projection and a perpendicular line, whereas the projection is the projection of the direction of the jet gas stream after introduction into the reactor on a projection plane, which crosses the tangent plane of the generally cylindrical shape of the middle zone at the location of the one or more feeding ports and along an intersection line between the tangent plane and the generally cylindrical surface of the middle zone, whereas the projection plane is located perpendicular to the tangent plane and whereas the perpendicular line crosses the generally cylindrical surface of the middle zone at the location of the one or more feeding ports, is parallel to the projection plane and is perpendicular to the tangent plane. Most preferably, the optimal introduction angle for introducing the jet gas stream has been found to be about 20°.

The number of feeding ports for introducing the jet gas stream is in the range of preferably 1 to 15, more preferably 2 to 10 and most preferably 2 to 5.

The feeding ports are preferably distributed across the middle zone of the gas-solids olefin polymerization reactor in axial and/or radial direction with the proviso that the jet gas stream is introduced into the dense phase.

The second stream is preferably split into the jet gas stream and the first stream of fluidization gas at a ratio of 5:95 (v/v) to 75:25 (v/v), preferably 7:93 (v/v) to 65:35 (v/v), most preferably 10:90 (v/v) to 50:50 (v/v).

Depending on the volume split between the jet gas stream and the first stream of fluidization gas, the jet gas stream has a certain pressure and contributes to the superficial gas velocity of the upwards flowing stream in the middle zone of the reactor.

It is further preferred that the superficial gas velocity of the upwards flowing stream of the fluidization gas in the middle zone of the reactor is from 0.3 to 1.2 m/s, more preferably from 0.4 to 1.0 m/s, most preferably from 0.5 to 0.9 m/s.

The fluidized bulk density of the dense phase during polymerization is in the range of from 100 to 500 kg/m³, preferably of from 120 to 470 kg/m³, most preferably of from 150 to 450 kg/m³.

In a preferred embodiment of the invention, the first line and/or the third line comprise heat exchanger. These heat exchangers can be used as heaters and/or as coolers.

### Cooling by the Jet Gas Stream

In a first preferred embodiment, the gas-solids olefin polymerization rector according of the multi-stage reactor-assembly of the present invention comprises a heat exchanger in the first line and/or a heat exchanger in the second line.

In a first more preferred embodiment of the first preferred embodiment of the invention, the reactor assembly comprises heat exchangers at the first and the third line, respectively. Preferably, these heat exchangers are configured to heat the fluidization gas and the jet gas up to temperatures having a temperature difference of at least 20° C., more preferably at least 30° C. and most preferably of at least 38° C., whereas the fluidization gas has higher temperature than the jet gas.

In a second more preferred embodiment of the first preferred embodiment of the invention, the reactor assembly comprises only one heat exchanger in the first line, whereas the jet gas stream in the third line is not heated at all and the fluidization gas in the first line is heated up to 40° C., preferably 50° C. and most preferably 60°.

In a third more preferred embodiment of the first preferred embodiment of the invention, the heat exchanger of the third line is a cooler. Preferably, in the cooler the jet gas stream of the third line is cooled as such that the jet gas stream in the third line comprises condensed fluidization gas preferably together with gaseous fluidization gas. Preferably, the jet gas stream comprises from 1 to 30 wt % condensed fluidization gas, more preferably from 3 to 25 wt % condensed fluidization gas and most preferably from 5 to 20 wt % condensed fluidization gas, based on the total weight of the jet gas stream of the third line. The remaining weight of the jet gas stream in the third line preferably consists of gaseous fluidization gas. Most preferably, the fluidization gas stream in the first line does not comprise condensed fluidization gas.

### Pressure Drop in the Jet Gas Line

In a second preferred embodiment of the present invention, the pressure difference between the jet gas stream in the third line and the polymerization pressure in the gas-solids polymerization reactor, ΔP, is at least 0.1 bar, preferably at least 1.0 bar, more preferably at least 3.0 bar, even more preferably at least 4.0 bar and most preferably at least 5.0 bar. The upper limit for the pressure difference is usually not higher than 10 bar, preferably not higher than 7 bar.

### Benefits of the Invention

It has been found that in the process of the present invention a higher fluidized bulk density of the dense phase can be obtained over the whole polymerization process.

As a consequence with the process of the present invention the gas-solids olefin polymerization reactor can be run under higher space-time yield or volume based production rate increasing the throughput or capacity of the reactor.

Without being bound by theory it is believed that the increase of fluidized bulk density results from a reduction of gas bubbles in the bottom and middle zone of the reactor

Further, the axial motion of the polyolefin powder in the top zone of the gas-solids olefin polymerization reactor is disturbed by the feed of the jet gas stream as such that the gaseous (and optional solid) content in the upper part of the middle zone and the top zone of the reactor is permanently accelerated in one direction. The introduced jet gas stream in the third line accelerates the downward flow of polymer solids close to the wall of the middle zone. This effect allows destruction of the axially moving polyolefin powder fountains and contributes to separating gas and solids, with solids moving downwards along the wall, “scraping” the wall permanently such that adhesive powder is washed away and wall sheeting can be suppressed thereby improving the reactor operability.

As a consequence the carry-over of particles of the polyolefin of the olefin monomer(s) into the second stream withdrawn from the top zone of the gas-solids olefin polymerization reactor is reduced thereby increasing the gas-solids separation efficiency and at the same time the cooling capacity of the process is not sacrificed.

### SHORT DESCRIPTION OF THE FIGURES

FIG. 1 shows a fluidized bed reactor as known from the prior art.

FIG. 2 shows a fluidized bed reactor according to the present invention having jet gas injection and means for providing energy to the fluidization gas and jet gas.

FIG. 3 shows a fluidized bed reactor according to the present invention having heat exchangers in the first line (6) and or the third line (8) FIG. 4 shows a fluidized bed reactor assembly according to the present invention having jet injection capabilities connected to a flash pipe from a preceding polymerization reactor.

FIG. 5 shows a schematic view of the reactor assembly as used in the examples RE1, CE1, and IE1-3.

FIG. 6 shows a diagram exemplifying the results of example IE4.

FIG. 7 shows a diagram exemplifying the results of examples RE3, CE4, and IE6.

### DETAILED DESCRIPTION OF THE FIGURES

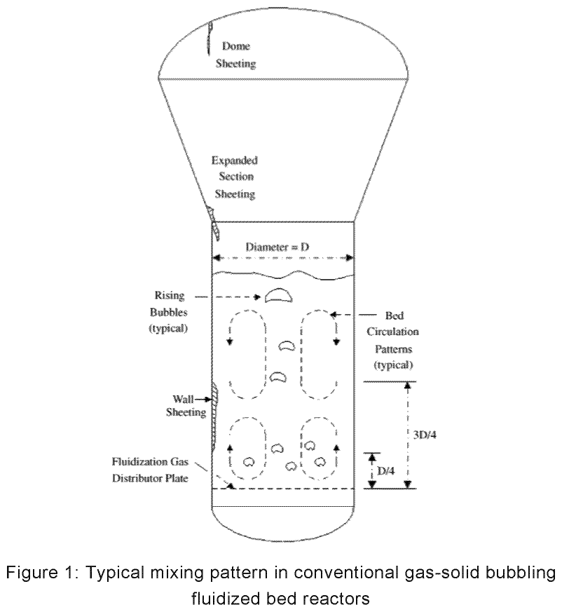

FIG. 1 shows a fluidized bed reactor as typically used. Typical hydrodynamic patterns are depicted. Gas bubbles generated by the distribution plate move preferably in the center of the reactor upwards. These bubbles in the center create a cylindrical hydrodynamic patter, in which the inner parts of the cylinder move upwards, while the outer parts move downwards. In the lower part of the reactor, where the centralizing of the bubbles has not happened yet, the above-described pattern induces another hydrodynamic pattern, which acts counter wise. As a result, there is a calm zone, in which the solid-gas mixture is not moving very rapidly. In this zone, wall sheeting can occur. Furthermore, as a result of solid entrainment into the disengaging zone, sheeting can also occur further upstream of the reactor middle zone.

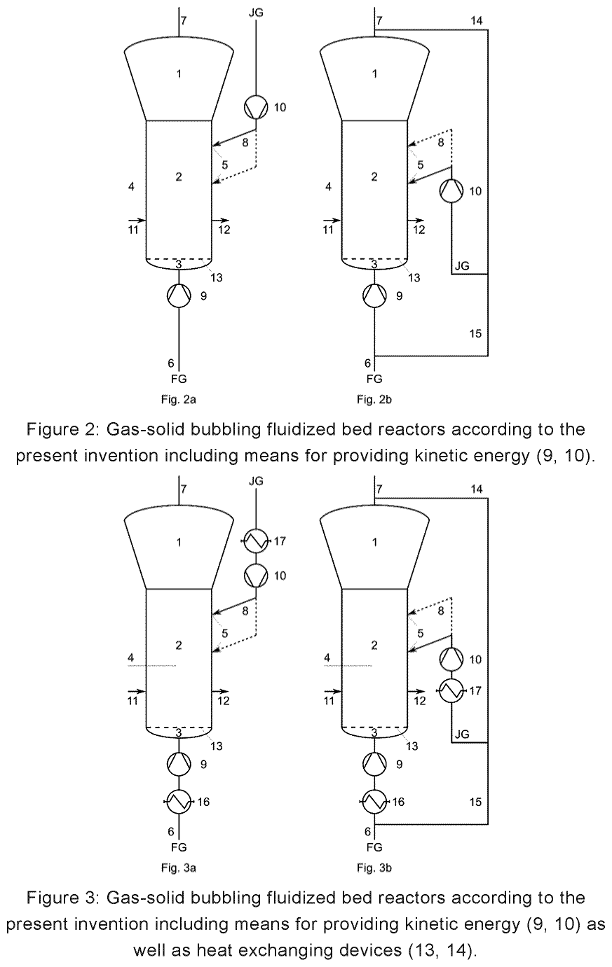

FIG. 2 shows an embodiment of the process according to the present invention in a fluidized bed reactor.

Reference signs
1 top zone (disengaging zone)
2 middle zone
3 bottom zone
4 fluidized bed (dense zone)
5 jet gas feeding port(s)
6 first line (fluidization gas (FG) input)
7 second line (fluidization gas output)
8 third line (jet gas (JG) input)
9 means for providing kinetic energy to the fluidization gas
10 cooler means for providing kinetic energy to the jet gas
11 feeding port for polymerization catalyst
12 polymer withdrawal
13 fluidization grid
14 fourth line connecting the third line (8) and the second line (7)
15 fifth line connecting the third line (8) and the first line (6)

### Description of FIG. 2

FIG. 2 shows an embodiment of the gas-solids olefin polymerization reactor system according to the present invention. The fluidized bed reactor comprises a top zone (1), a middle zone (2) and a bottom zone (3). The first stream of fluidization gas (6) enters the fluidized bed reactor through the bottom zone (3) and flows upwards, thereby passing a fluidization grid (13) and entering the middle zone (2). Due to the substantially cylindrical shape of the middle zone (2) the gas velocity is constant so that the fluidized bed (4) is established after the fluidization grid (13) in the middle zone (2). Due to the conical shape of the top zone (1) the gas entering the top zone (1) expands so that the gas disengages from the polyolefin product of the polymerization reaction so that the fluidized bed (4) is confined in the middle zone (2) and the lower part of the top zone (2). The polymerization catalyst together with optional polyolefin powder polymerized in previous polymerization stage(s) is introduced into the fluidized bed reactor through at least on feeding port (11) directly into the fluidized bed (4). The polyolefin product of the polymerization process is withdrawn from the fluidized bed reactor through outlet (12).

The fluidized gas is withdrawn from the top zone (1) as second stream of fluidization gas (7). The first line (6) transporting the fluidization gas comprises means (9) for providing kinetic energy to the fluidization gas. Furthermore, the third line (8) transporting the jet gas comprises another means (10) for providing kinetic energy to the jet gas. These means are configured in that the ratio of the kinetic energy of the jet gas (EJG) introduced into the reactor to the kinetic energy of the fluidization gas introduced into the reactor is 1.0 to 50, preferably 1.7 to 25, and most preferably 2.0 to 15. The means can be any means for providing the gas streams with kinetic energy. Such means comprise blowers, compressors, such as screw compressors, and fans. Preferably, the means are blowers or compressors. More preferably, the means are blowers. In one preferred embodiment, the means for providing kinetic energy to the fluidization gas is a blower and the means for providing kinetic energy to the jet gas is a screw compressor.

In a particularly preferred embodiment of the invention, the solids-gas reactor according to the present invention (FIG. 2b) further comprises a fourth line (14) connecting the second line (7) and the third line (8) as well as a fifth line (15) connecting the third line (8) and the first line (6). Hence, in this embodiment at least part of the fluidization gas leaving the reactor from the top zone is recycled and reintroduced into the reactor either as fluidization gas or jet gas. The advantage of such an arrangement is that lower amounts of fluidization gas is needed and the overall process is less energy consuming as at least part of the heat as removed with the fluidization gas from the reactor is reintroduced at the bottom or via the jet gas feeds reducing the amount of energy needed to bring the gas streams to the temperature as needed for the reaction on the reactor.

FIG. 3 shows another embodiment of the process according to the present invention in a fluidized bed reactor.

### REFERENCE SIGNS

The reference sign 1-15 are identical to FIG. 2.
16 heat exchanger located in the first line (6) for feeding the fluidization gas into the reactor.
17 heat exchanger located in the third line (8) for feeding the jet gas into the reactor

### Description of FIG. 3

FIG. 3 demonstrates a first preferred embodiment of the present invention. In addition to the setup as shown in FIG. 2 and described above, the reactor assembly comprises heat exchangers (1, 17) in the first line (6) for introducing fluidization gas and in the third line (8) for introducing jet gas into the reactor. These heat exchangers might be used for cooling and/or for heating the respective gas streams.

In a first more preferred embodiment of the first preferred embodiment of the present invention, both heat exchangers are used for heating up the streams to a certain temperature suiting the needs for the polymerization reaction in the reactor. More preferably, the reactor assembly comprises heat exchangers (16) and (17) at the first line (6) and the third line (8), respectively. These heat exchangers are configured to heat the fluidization gas and the jet gas up to temperatures having a temperature difference of at least 20° C., preferably at least 30° C. and most preferably of at least 38° C., whereas the fluidization gas has higher temperature than the jet gas.

In a second more preferred embodiment of the first preferred embodiment according to the present invention, the reactor assembly comprises only heat exchanger (16) in the first line (6), whereas the jet gas stream (8) is not heated at all and the fluidization gas is heated up to 40° C., preferably 50° C. and most preferably 60°.

Above-mentioned features could also be applied to a reactor assembly independently from the means for providing energy to the fluidization gas and jet has stream (9, 10) without losing the technical advantage. As indicated in FIG. 3b, the features of the additional heat exchangers can be combined with the features of the fluidization gas recirculation (e.g. lines 14/15).

These embodiments have the technical advantage that in the reactors of these embodiments show reduced solid entrainment in the upper part of the reactor at maintained cooling capabilities of the reactor. Further, improved mass and heat transfer results from setups according to the first more preferred embodiment.

In a third more preferred embodiment of the first preferred embodiment of the present invention, the heat exchanger (17) located in the third line (8) is a cooler. In such an embodiment, the cooler (17) is configured to provide an at least partially condensed jet gas stream into to be introduced into the reactor.

Also in the third more preferred embodiment of the first preferred embodiment of the present invention, above-mentioned features could also be applied to a reactor assembly independently from the means for providing energy to the fluidization gas and jet has stream (9, 10) without losing the technical advantage. As indicated in FIG. 3b, the feature of the additional cooler can be combined with the features of the fluidization gas recirculation (e.g. lines 14/15).

Such a setup has the technical advantage of improving heat removal by increased heat transfer without having the risk of blocking of the distribution grid and wetting of the lower part of the fluidized bed avoiding formation of agglomerations such as lumps.

FIG. 4 shows another embodiment of the process according to the present invention in a fluidized bed reactor.

### REFERENCE SIGNS

The reference sign 1-15 are identical to FIG. 2.
18 flash pipe jet gas feeding port(s)
19 sixth line connecting a flash pipe (FB) to reactor via feeding port(s) 18.
FP flash pipe from a preceding polymerization reactor

As can be seen in FIGS. 4a-c, in this second preferred embodiment of the present invention, either the whole jet gas injection system is completely replaced by a solids-gas stream derived from a flash pipe (FP, 5, 8; FIG. 4a) or at least one jet stream is derived from a flash pipe (FP, 18, 19, FIG. 4b-c) in addition to the jet stream as already described in the embodiments of FIGS. 2 and 3 (JG, 5, 8; FIG. 4b-c). Further combinations can be implemented, e.g. a reactor assembly having flash pipe jet gas input and fluidization gas recirculation without the jet gas injection as described in the embodiments of FIGS. 2 and 3 (i.e. line 8 via port(s) 5). As indicated by the dotted lines of the heat exchanger (16, 17), the features of the present embodiment can be used in combination with the features and improvements of the embodiment according to FIG. 3, but also without. The same holds in parallel to the embodiments according to FIG. 3 for the feature of the means for providing kinetic energy to the fluidization gas and the jet gas, respectively.

The stream derived from a flash pipe of a preceding polymerization reaction, preferably a polymerization reactor for the polymerization of polypropylene, most preferably a loop polymerization reactor for the polymerization of polypropylene, has a very high energy (momentum). Hence, the resulting jet gas stream has also much higher energy than the jet gas stream as provided by the fluidization gas. The technical effect of such an embodiment is that the hydrodynamic pattern as found in typical fluidized bed reactors (i.e. without jet gas injection) can be more efficiently destroyed yielding an increase in bulk density at reduced solids carry-over.

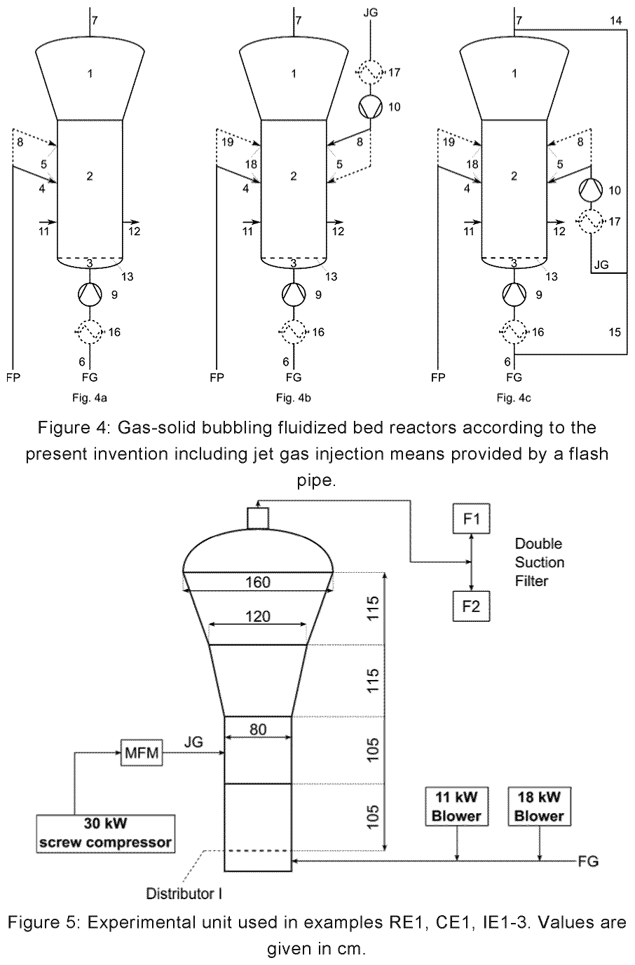

FIG. 5 shows the reactor assembly as used in the examples in the present invention. The numbers given in the figure relate to respective heights and widths of the components of the assembly given in centimeters. The fluidization gas (FG) is accelerated by an 11 kW blower and an 18 kW blower and enters the bottom zone of the reactor before passing the distribution grid (Distributor 1). The jet gas (JG) is compressed by a 30 kW screw compressor and passes a mass flow meter (MFM) before entering the reactor to determine the kinetic energy provided to the jet gas stream. Finally, the fluidization gas removed from the top zone is directed to a double suction filter to analyze the solids carry over effect.

### Examples

A gas-solids olefin polymerization reactor according to FIG. 5 (values in cm) was used for examples RE1, CE1, and IE1-3. This reactor is equipped with a fluidization grid (Distributor 1), a catalyst feeding port and a disengaging zone to assess the effect of the ratio of the power inputs on the solids carry over. The reactor had a diameter of 0.8 m and height of 4.4 m. The following experimental procedure steps were followed for all the gas experiments:
i) Starting to inject fluidization gas (FG, air) into the bottom of the fluidized bed reactor to form the bottom of the fluidized bed (FB)
ii) Feeding polyolefin powder with a powder feed of 10 kg/min through the catalyst feeding port to form the fluidized bed (FB)
iii) Increasing the fluidized bulk density (BD) of the bed in the middle zone of the fluidized bed reactor to about 310 kg/m³
iv) Starting to inject air (jet gas (JG)) through one feeding port situated in the middle zone of the fluidized bed reactor (only CE1 and IE1-3)
v) Stopping polymer powder feed
vi) Keeping fluidization gas (FG) and (JG) feed constant

### Reference Example 1 (RE1)

The gas-solids olefin polymerization reactor was filled with LLDPE powder up to 130 cm height yielding a bulk density of 445 kg/m³ and was fluidized with air with a density equal to 1.2 kg/m³ under a volumetric flow of 543 m³/h (corresponding to a superficial gas velocity of 0.30 m/s). The pressure drop over the bed was 56.31 mbar and the power dissipated to the fluidized reactor via the fluidization gas calculated according to equation 1 was 0.876 kW.

### Comparative Example 1 (CE1)

Reference Example 1 was repeated with the only difference that jet gas was used with a split of 25% v/v. Thus, 407 m³/h air was used as fluidization gas and the rest (136 m³/h) was used as jet gas. The pressure drop across the jet gas line was equal to 0.3 bar and a nozzle with an internal diameter equal to 3.3 cm was employed to inject the jet gas. The power input by the jet gas line to the fluidized reactor calculated according to equation 2 was 0.989 kW, the energy split (i.e., power input by the jet gas divided by the power input by the fluidization gas), was 1.13. No reduction in solids carry over and no increase in fluidized bed density was observed during operation.

### Inventive Example 1 (IE1)

Comparative Example 2 was repeated with the same jet gas split. Thus, 407 m³/h air was used as fluidization gas and the rest (136 m³/h) was used as jet gas. The pressure drop across the jet gas line was 0.5 bar and a nozzle with an internal diameter of 2.6 cm was employed to inject the jet gas. The power input by the jet gas line to the fluidized reactor calculated according to equation (III) was 1.53 kW, the energy split (i.e., power input by the jet gas divided by the power input by the fluidization gas), was 1.75. A reduction in solids carry over and an increase in fluidized bed density was observed during operation starting from the injection of the jet gas. At the steady state the increase was 3%.

### Inventive Example 2 (IE2)

Comparative Example 1 was repeated with the same jet gas split. Thus, 407 m³/h air was used as fluidization gas and the rest (136 m³/h) was used as jet gas. The pressure drop across the jet gas line was 1.0 bar and a nozzle with an internal diameter of 1.8 cm was employed to inject the jet gas. The power input by the jet gas line to the fluidized reactor calculated according to equation (III) was 2.6 kW, the energy split (i.e., power input by the jet gas divided by the power input by the fluidization gas), was 3.0. A significant reduction in solids carry over and an increase in fluidized bed density was observed during operation starting from the injection of the jet gas. At the steady state the increase was 7%.

### Inventive Example 3 (IE3)

Comparative Example 1 was repeated with the same jet gas split. Thus, 407 m³/h air was used as fluidization gas and the rest (136 m³/h) was used as jet gas. The pressure drop across the jet gas line was 2.0 bar and a nozzle with an internal diameter of 1.3 cm was employed to inject the jet gas. The power input by the jet gas line to the fluidized reactor calculated according to equation (III) was 4.14 kW, the energy split (i.e., power input by jet gas divided by the power input by the fluidization gas), was 4.75. A significant reduction in solids carry over and a significant increase in fluidized bed density was observed during operation starting from the injection of the jet gas. At the steady state the increase was 12%.

TABLE 1
Results dependent on the EJG/ EFG ratio.

| | RE1 | CE1 | IE1 | IE2 | IE3 |
|---|---|---|---|---|---|
| E_{FG} [kW] | 0.876 | 0.876 | 0.876 | 0.876 | 0.876 |
| E_{JG} [kW] | − | 0.989 | 1.53 | 2.6 | 4.14 |
| E_{JG}/E_{FG} | − | 1.13 | 1.75 | 3.0 | 4.75 |
| Reduction solids | 0 | 0 | + | ++ | ++ |
| carry over | | | | | |
| Increase bulk | 0 | 0 | + | + | ++ |
| density | | | | | |

0 no reduction/increase
+ reduction/increase
++ significant reduction/increase

### Inventive Example 4 (IE4)

This example is used to illustrate the technical effect of the first preferred embodiment according to FIG. 3.

The fluidized bed (FB) of the reactor was filled up to 86 cm with HDPE powder and fluidized with cold fluidization gas first. The superficial gas velocity just above the distribution grid was 0.37 m/s.

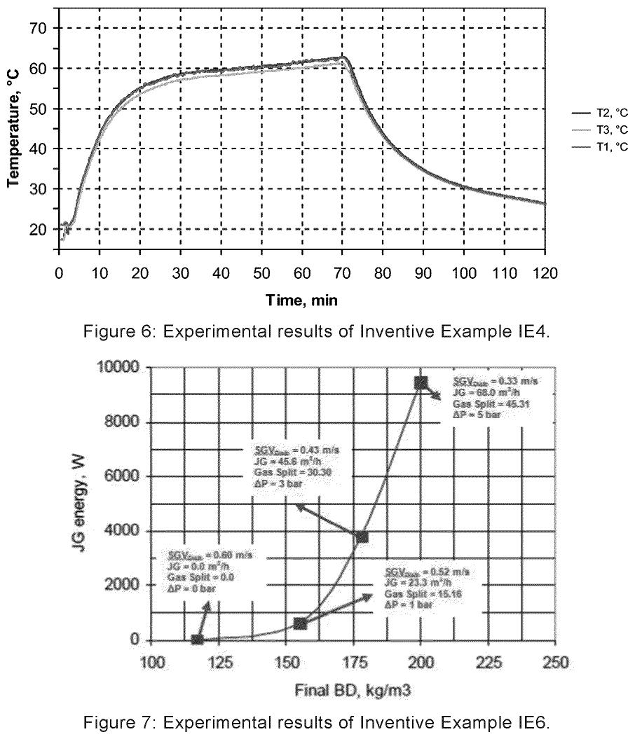

At t=2.5 min (cf. FIG. 6), the heating of the fluidization gas stream was switched and the fluidization gas stream was heated up to 65° C. The fluidized bed was heated at a constant fluidization gas flow of 91 m³/h until thermal equilibrium was reached after 70 min.

At t=72 min, the jet gas injection was switched on for cooling at flow of 46 m³/h jet gas and at a pressure drop of 3 bar. The temperature of the jet gas was 25° C. (room temperature).

It can be seen from the temperature profile as depicted in FIG. 6 that the cooling of the powder by the jet gas stream is very effective. The contact between gas and powder leads to an improved heat exchange and the good mixing of the bed leads to a smooth decreasing of bed temperature. Consequently, the jet gas stream does not only contribute in decreasing the solids carry over, sufficient heat removal but also in close to ideal gas-solids mixing.

The latter effect is evident by the fact that the temperature in the dense phase of the fluidized bed (i.e. T1, cf. FIG. 6) is very close to the temperature of the fluidization gas in the top zone (T3) as well as the temperature of the jet gas (T2). Such a temperature profile is a good indication of efficient mixing conditions (T1, T2 and T3 collapse to the same line from t=72 min onwards).

### Reference Example 2 (RE2)

In the following examples RE2, CE2-3 and IE5 the technical effect of the second preferred embodiment according to FIG. 3 is demonstrated.

An ethylene-1-butene polymerization process in a gas-solids olefin polymerization reactor equipped with a distribution plate was used. 5% mole of 1-butene was added to the gas-solids olefin polymerization reactor. The reactor was operated at an absolute pressure of 20 bar and a temperature of 85° C. Propane was used as fluidization gas. The bed was formed from polyethylene (LLDPE) particles having an average diameter (d₅₀) of 400 μm. The LLDPE had a density of 923 kg/m³ and a MFR₅ of 0.23 g/10 min.

The dimensions of the reactor assembly were:

Height of the bottom zone: 900 mm

Height of the middle zone: 2700 mm

Height of the upper zone: 415 mm

Diameter of the middle zone: 540 mm

The reactor as described above was operated so that flow rate of the fluidization gas was 570 m³/h. The bed was filled with LLDPE with a filling degree of about 60% of the volume of the middle zone. The superficial gas velocity at the gas inlet, where the diameter of the reactor was 100 mm, was 16 m/s and in the middle zone 0.7 m/s. The heat removal rate was estimated around 1.7 K/h. No jet gas stream was employed.

### Comparative Example 2 (CE2)

The procedure of Reference Example 2 was repeated with the exception that 15 wt % of the gas feed was condensed (i.e. 15 wt % condensed fluidization gas). The heat removal rate was 1.9 K/h.

### Comparative Example 3 (CE3)

The procedure of Reference Example 2 was repeated with the only difference that jet gas injection was employed with a central cooler for both the jet gas line and the fluidization gas line. Hence, 25 vol % of the gas-liquid mixture volume was injected as jet gas and the remaining 75 vol % was fed to the reactor via the bottom zone as fluidization gas. Overall 15 wt % condensed fluidization gas was injected in the reactor. This fluidization gas was condensed by the central cooler. Consequently, 75 wt % of the condensed fluidization gas was fed in the bottom zone and the remaining 25 wt % was fed via the jet gas line. The heat removal rate was 2.2 K/h.

### Inventive Example 5 (IE5)

The procedure of Comparative Example 3 was repeated with the only difference that the jet gas was employed following the process design illustrated in FIG. 3. Hence, the cooler was placed separately in the jet gas line only. Thus, 25 vol % was injected as jet gas stream and the remaining 75 vol % of was fed to the reactor via the bottom part. Overall, 15 wt % condensed fluidization gas was injected in the reactor. In contrast to Comparative Example 1, it was fed exclusively via the jet gas feeding port. The heat removal rate was 2.6 K/h.

### Reference Example 3 (RE3)

In the following examples RE3, CE4, and IE6 the technical effect of the embodiment according to FIG. 4 is demonstrated. The following experimental procedure was followed for all experiments:
i) Injection of fluidization gas (FG) in the bottom zone of the reactor.
ii) Starting the powder feed via the feed screw (7.65 kg/min) into the reactor.
iii) Increasing the reactor fluidized bed density until it reaches 300 kg/m³.
iv) Optionally injecting jet gas (JG, CE4, IE6).
v) Stopping the powder feed.
vi) Keeping the fluidization gas (FG) and jet gas (JG) streams constant.

In this example no jet gas injection was employed. The superficial gas velocity at the end of the dense phase of the fluidized bed reactor (i.e., end of the cylindrical section of the reactor) was constant and equal to 0.60 m/s (also the superficial gas velocity just above the distribution plate was equal to 0.6 m/s since not jet gas was introduced). The conditions and the main results related to the reference fluidization experiment are illustrated in Table 2.

TABLE 2
Experimental fluidization conditions using a
jet gas stream.

| Conditions | Values |
|---|---|
| FG Flow, m³/h | 152.5 (100% split) |
| JG Pressure drop, P_{JG}, bar | 0 |
| JG Flow, m³/h | 0.00 (0% split) |
| JG Velocity, m/h | 0.00 |
| Overall Gas Feed, m³/h | 152.5 |
| SGV, m/s | 0.60 |
| SGV_{Distr}, m/s | 0.60 |
| Fluidized Bed Density, ρ_{bed}, kg/m³ | 115 |

### Comparative Example 4 (CE4)

Reference Example 3 was repeated by employing superficial gas velocity just above the distribution plate equal to 0.51 m/s (i.e. 129.2 m³/h). Moreover, 23.3 m³/h was used as jet gas with a pressure drop of 1 bar so that the overall superficial gas velocity was 0.60 m/s, cf. Table 3. It can be seen that the jet gas stream significantly reduces the solids carry over, while the bulk density of the fluidized bed increases from 115 kg/m³ to 200 kg/m³).

TABLE 3
Experimental fluidization conditions using a
jet gas stream.

| Conditions | Values |
|---|---|
| FG Flow, m³/h | 129.0 (84.7% split) |
| JG Pressure drop, ΔP_{JG}, bar | 1 |
| JG Flow, m³/h | 23.3 (15.3% split) |
| JG Velocity, m/h | 0.09 |
| Overall Gas Feed, m³/h | 152.50 |
| SGV, m/s | 0.60 |
| SGV_{Distr}, m/s | 0.51 |
| Fluidized Bed Density, ρ_{bed}, kg/m³ | 155 |

### Inventive Example 6 (IE6)

Reference Example 3 was repeated by employing superficial gas velocity just above the distribution plate of 0.33 m/s (i.e. 84.5 m³/h). Moreover, 68.0 m³/h was used as jet gas stream with a pressure drop of 5 bar so that the overall superficial gas velocity was 0.60 m/s.

The huge pressure drop across the jet gas injection pipe was selected to simulate the energy input coming from the gas-solid stream which in practice can be injected e.g. from a loop reactor via a flash pipe.

It can be seen from Table 4 that introducing such an energy input into the reactor makes it possible to substantially increase the fluidized bed density which in turn to reduces the solids carry over.

Hence, Inventive Example 7 suggests that injecting a gas-solid mixture with an increased pressure drop as jet gas results in increase of the bulk density and in decrease of the solids entrainment (cf. also FIG. 7).

TABLE 4
Experimental fluidization conditions
using a gas-solids stream (simulated via 5 bar
pressure drop across JG injection pipe).

| Conditions | Values |
|---|---|
| FG Flow, m³/h | 84.5 (55.4% split) |
| JG Pressure drop, ΔP_{JG}, bar* | 5 |
| JG Flow, m³/h | 68.0 (44.6% split) |
| JG Velocity (equivalent), m/h | 0.27 |
| Overall Gas Feed, m³/h | 152.5 |
| SGV, m/s | 0.60 |
| SGV_{Distr}, m/s | 0.33 |
| Fluidized Bed Density, ρ_{bed}, kg/m³ | 200 |

1. A process for polymerizing olefin monomer(s) in a gas-solids olefin polymerization reactor comprising:
a top zone (1);
a middle zone (2), which comprises a top end in direct contact with said top zone and which is located below said top zone (1), the middle zone (2) having a generally cylindrical shape; and
a bottom zone (3), which is in direct contact with a bottom end of the middle zone (2) and which is located below the middle zone (2);
comprising the following steps:
a) introducing a fluidization gas stream (6, FG) into the bottom zone (3);
b) polymerizing olefin monomer(s) in the presence of a polymerization catalyst in a dense phase (4) formed by particles of a polymer of the olefin monomer(s) suspended in an upwards flowing stream of the fluidization gas in the middle zone (2);
c) introducing a jet gas stream (8, JG) through one or more jet gas feeding ports (5) in a jet gas feeding area of the middle zone (2) at the dense phase (4) in the middle zone (2) of the gas-solids olefin polymerization reactor;
wherein
the kinetic energy (E_{JG}) input in the gas-solids olefin polymerization reactor by the jet stream (JG) is between 1.0 and 50 times higher than the kinetic energy (E_{FG}) input in the gas-solids olefin polymerization reactor by the fluidization gas stream (FG) as expressed by relation (I)
$$1.0 \leq \frac{{E}_{JG}}{{E}_{FG}} \leq 50 \qquad ( I )$$
wherein the kinetic energy of the fluidization gas (E_{FG}) is calculated according to equation (II):
$${E}_{FG} = {P}_{FG} \cdot {V}_{FG} \cdot ln ( \frac{{P}_{FG}}{{P}_{FG} - h \cdot ρ \cdot g} ) \qquad ( II )$$
with
E_{FG} being the energy dissipated by the expansion of the fluidisation gas into the fluidized bed, [W]
P_{FG} being the pressure of the fluidisation gas at the bottom of the gas-solids olefin polymerization reactor, [Pa]
V_{FG} being the volumetric flow rate of the fluidisation gas, [m³/s]
h being the bed height of the collapsed bed, [m]
ρ being the bulk density of the collapsed bed, [kg/m³]
g being the gravity constant, [m/s²]
and wherein the kinetic energy of the jet gas (E_{JG}) is calculated according to equation (III):
$${E}_{JG} = {P}_{JG} \cdot {V}_{JG} \cdot ln ( \frac{{V}_{{FG}_{2}}}{{V}_{JG}} ) \qquad ( III )$$
with
E_{JG} being the energy dissipated by the expansion of the jet gas into the fluidized bed, [W]
P_{JG} being the pressure of the jet gas at entry in the gas-solids olefin polymerization reactor, [Pa]
V_{FG2} being the volumetric flow rate of the fluidisation gas, [m³/s]
V_{JG} being the volumetric flow rate of the jet gas, [m³/s].

2. The process according to claim 1, wherein the fluidization gas is removed from the top zone (1) of the reactor and at least a part of the fluidization gas is introduced into the jet gas stream (8) and into the fluidization stream (6).

3. The process according to claim 1, wherein the jet gas stream (JG) fed through at least one of the one or more jet gas feeding ports (5) is provided by a flash pipe (FP) from a preceding reactor, preferably a reactor for polymerizing polypropylene, more preferably a loop reactor for polymerizing polypropylene.

4. The process according to claim 1, wherein the jet gas stream (JG) is cooled to yield a partially condensed jet gas stream and wherein the fluidization gas stream (FG) is not condensed.

5. The process according to claim 1, wherein the fluidization gas stream (FG) in the first line (6) and the jet gas stream (JG) in the third line (8) are heated up, wherein the temperature difference between the jet gas stream (JG) and the fluidization gas stream (FG) is at least 20° C., preferably at least 30° C. and most preferably of at least 38° C., wherein the temperature of the fluidization gas stream (FG) is higher than the temperature of the jet gas stream (JG).

6. A reactor assembly for polymerizing olefin monomer(s) comprising
a gas-solids olefin polymerization reactor comprising:
a top zone (1);
a middle zone (2), which comprises a top end in direct contact with said top zone (2) and which is located below said top zone (1), the middle zone (2) having a generally cylindrical shape; and
a bottom zone (3), which is in direct contact with a bottom end of the middle zone (2) and which is located below said middle zone (2);
one or more feeding ports (5) located in a feeding area of the middle zone (2);
a first line (6) for feeding a fluidization gas stream (FG) into the bottom zone (3) of the gas-solids olefin polymerization reactor,
a second line (7) for withdrawing a stream comprising fluidization gas from the top zone (1) of the gas-solids olefin polymerization reactor,
a third line (8) for introducing a jet gas stream (JG) into the middle zone (2) of the gas-solids olefin polymerization reactor via the one or more feeding ports (5), and
means (9) located in the first line (6) for providing kinetic energy to the fluidization gas stream (FG) prior to entry of the gas-solids olefin polymerization reactor and means (10) located in the third line (8) for providing kinetic energy to the jet gas stream (FG) prior to entry of the gas-solids olefin polymerization reactor,
wherein
the means for providing kinetic energy to the fluidization gas stream (9) and the means for providing kinetic energy to the jet gas stream (10) are configured so that the kinetic energy (E_{JG}) input in the gas-solids olefin polymerization reactor by the jet stream (JG) is between 1.0 and 50 times higher than the kinetic energy (E_{FG}) input in the gas-solids olefin polymerization reactor by the fluidization gas stream (FG) as expressed by relation (I)
$$1.0 \leq \frac{{E}_{JG}}{{E}_{FG}} \leq 50 \qquad ( I )$$
wherein the kinetic energy of the fluidization gas (E_{FG}) is calculated according to equation (II):
$${E}_{FG} = {P}_{FG} \cdot {V}_{FG} \cdot ln ( \frac{{P}_{FG}}{{P}_{FG} - h \cdot ρ \cdot g} ) \qquad ( II )$$
with
E_{FG} being the energy dissipated by the expansion of the fluidisation gas into the fluidized bed, [W]
P_{FG} being the pressure of the fluidisation gas at the bottom of the gas-solids olefin polymerization reactor, [Pa]
V_{FG} being the volumetric flow rate of the fluidisation gas, [m³/s]
h being the bed height of the collapsed bed, [m]
ρ being the bulk density of the collapsed bed, [kg/m³]
g being the gravity constant, [m/s²]
and wherein the kinetic energy of the jet gas (E_{JG}) is calculated according to equation (III):
$${E}_{JG} = {P}_{JG} \cdot {V}_{JG} \cdot ln ( \frac{{V}_{{FG}_{2}}}{{V}_{JG}} ) \qquad ( III )$$
with
E_{JG} being the energy dissipated by the expansion of the jet gas into the fluidized bed, [W]
P_{JG} being the pressure of the jet gas at entry in the gas-solids olefin polymerization reactor, [Pa]
V_{FG2} being the volumetric flow rate of the fluidisation gas, [m³/s]
V_{JG} being the volumetric flow rate of the jet gas, [m³/S]

7. The reactor assembly according to claim 6, wherein the means for providing kinetic energy to the jet gas stream (10) is a flash pipe (FP) from a preceding reactor, preferably a reactor for polymerizing polypropylene, more preferably a loop reactor for polymerizing polypropylene.

8. The reactor assembly according to claim 7, wherein the gas-solids olefin polymerization reactor further comprises:
one or more flash pipe feeding ports (18) located in a feeding area of the middle zone (2); and
a sixth line (19) for introducing a flash pipe gas stream (FP) into the bottom zone (2) of the gas-solids olefin polymerization reactor via the one or more flash pipe feeding ports (18).

9. The reactor assembly according to claim 6 further comprising a heat exchanging device (16) in the first line (6) and/or a heat exchanging device (17) in the third line (8).

10. The reactor assembly according to claim 9, wherein the heat exchanging device (17) is a cooler for cooling the jet gas stream (JG) to a partially condensed jet gas stream and wherein the fluidization gas stream (FG) is not condensed.

11. The reactor assembly according to claim 9, wherein the heat exchanging device (16) in the first line (6) and the heat exchanging device (17) in the third line (8) are heaters and wherein the heat exchanging devices (16, 17) are configured to heat the fluidization gas stream (FG) in the first line (6) to a higher temperature than the jet gas stream (JG) in the third line (8).

12. The process of claim 1, wherein the carry-over of particles of the polyolefin of the olefin monomer(s) into the second stream withdrawn from the top zone of the gas-solids olefin polymerization reactor is reduced.

13. The process of claim 1, wherein the bulk density of the dense phase is increased during polymerization.

14. The reactor assembly of claim 6, wherein the carry-over of particles of the polyolefin of the olefin monomer(s) into the second stream withdrawn from the top zone of the gas-solids olefin polymerization reactor is reduced.

15. The reactor assembly of claim 6, wherein the bulk density of the dense phase is increased during polymerization.
